(19) United States
(12) Patent Application Publication
(10) Pub. No.: US 2024/0420064 A1
(43) Pub. Date: Dec. 19, 2024

(54) Productivity Management System

(71) Applicant: Juan Jose Basanez, Sunny Isles, FL (US)

(72) Inventor: Juan Jose Basanez, Sunny Isles, FL (US)

(21) Appl. No.: 18/336,983

(22) Filed: Jun. 17, 2023

(51) Int. Cl. G06Q 10/0639; G06Q 10/0631

(52) U.S. Cl. CPC G06Q 10/06398; G06Q 10/063114

(57) ABSTRACT

A computer implemented method for obtaining one or more productivity scores and an activity summary for an end-user of an application program, and a computer program product having a non-transitory computer readable storage medium with program instructions embodied therewith are provided. The method and product are configured to capture, index, and store data and information for activities completed by the end-user during the work schedule; transmit the data and information to an administrator of the application program; and display an activity summary and productivity score for the end-user based on the data and information.

### FIELD

The present disclosure generally relates to computer software, and more specifically to productivity management software, and even more specifically to a real-time productivity management system for evaluating the activities of system users. The productivity management system can be utilized in any industry, including, for example, industries that involve call centers, dispatch centers, and the like. Exemplary industries include trucking, shipping, and logistics.

### BACKGROUND

Existing software products, particularly in the trucking, shipping, and logistics industries, can determine whether a computer user is active on a computer system or not, but such software lacks additional functionality for tracking the specific activities of the user, classifying each of the activities, and displaying an activity history for the user activities and a dashboard summary of the classified activities on a user interface. Accordingly, there remains a need for an improved productivity management software that can provide users, including employers or supervisors, with the comprehensive data and information needed to evaluate team members and software users (e.g., employees, contractors).

### SUMMARY

In various embodiments, a computer implemented method for obtaining one or more productivity scores and an activity summary for an end-user of an application program, comprising: providing the application program for carrying out the method; assigning a work schedule to the end-user, the work schedule comprising a first list of days and hours for each of the respective days in which the end-user should be using the application program; indexing and storing data and information in a database for one or more activities completed by the end-user during the work schedule, wherein the data and information comprises a description, a start time, an end time, and a duration for each respective activity of the one or more activities; assigning each respective activity to one or more status categories, the one or more status categories comprising first active, second active, phone calls, and logout; calculating one or more productivity scores for the end-user, the one or more productivity scores comprising a current month score spanning from an initial (first selected) day of a current month to a present (second selected) day of the current month, wherein the calculating is based on the duration for the one or more activities in the first active status category and the first list of days and hours in the work schedule for the current month; transmitting the indexed and stored data and information for the one or more activities, the one or more status categories assigned to each of the one or more activities, and the one or more productivity scores to an administrator of the application program; and displaying a user interface for the administrator, the user interface comprising: the activity summary, comprising a chronological history for each of the one or more status categories, wherein the chronological history includes at least a portion of the work schedule; a first register comprising each of the one or more activities completed by the end-user during the work schedule, the one or more status categories assigned to each respective activity of the one or more activities completed by the end-user during the work schedule, and the description of each respective activity of the one or more activities completed by the end-user during the work schedule; and the one or more productivity scores for the end-user.

In some embodiments, the one or more activities comprises website visited, hyperlink clicked, phone call, application program log-in, application program log-off, and inactivity.

In some embodiments, the first active status category comprises website visited, hyperlink clicked, and application program login.

In some embodiments, the second active status category comprises inactivity, wherein the inactivity is defined by a first predetermined period in which the end-user is not engaged in another activity of the one or more activities.

In some embodiments, the one or more status categories further comprises a third active; wherein the third active status category comprises inactivity; wherein the inactivity is defined by a second predetermined period in which the end-user is not engaged in another activity of the one or more activities; and wherein the second predetermined period is greater than the first predetermined period.

In some embodiments, the one or more status categories further comprises a calendar; wherein the calendar comprises a second list of days and hours for each of the respective days in which the end-user should not be using the application program.

In some embodiments, the application program log-off is defined by an end-user instruction to end access to the application program.

In some embodiments, the one or more productivity scores further comprises a total score spanning from the initial (first selected) day of an initial month to the present (second selected) day of the current month, the initial day being when the end-user started using the application program, wherein the calculating is based on the duration for the one or more end-user activities in the first active status category and the first list of days and hours in the work schedule for each month since the initial month.

In some embodiments, the user interface further comprises a text input window for inputting a question to the end-user, and a first call-to-action button for transmitting the question to the end-user. In some embodiments, the user interface further comprises a text input window for inputting a phone call record, and a second call-to-action button for transmitting the phone call record to the database.

In some embodiments, the phone call comprises data and information including telephone number, telephone contact, duration of phone call, and optionally, notes about the phone call.

In some embodiments, the user interface further comprises a drop-down menu for selecting a specific status category and a third call-to-action button for displaying a second register comprised of only the specific status category selected.

In various embodiments, a computer program product comprising a non-transitory computer readable storage medium having program instructions embodied therewith, the program instructions executable by a computer processor to cause the computer processor to perform a method, comprising: providing the application program for carrying out the method; assigning a work schedule to the end-user, the work schedule comprising a first list of days and hours for each of the respective days in which the end-user should be using the application program; indexing and storing data and information in a database for one or more activities completed by the end-user during the work schedule, wherein the data and information comprises a description, a start time, an end time, and a duration for each respective activity of the one or more activities; assigning each respective activity to one or more status categories, the one or more status categories comprising first active, second active, phone calls, and logout; calculating one or more productivity scores for the end-user, the one or more productivity scores comprising a current month score spanning from an initial (first selected) day of a current month to a present (second selected) day of the current month, wherein the calculating is based on the duration for the one or more activities in the first active status category and the first list of days and hours in the work schedule for the current month; transmitting the indexed and stored data and information for the one or more activities, the one or more status categories assigned to each of the one or more activities, and the one or more productivity scores to an administrator of the application program; and displaying a user interface for the administrator, the user interface comprising: the activity summary, comprising a chronological history for each of the one or more status categories, wherein the chronological history includes at least a portion of the work schedule; a first register comprising each of the one or more activities completed by the end-user during the work schedule, the one or more status categories assigned to each respective activity of the one or more activities completed by the end-user during the work schedule, and the description of each respective activity of the one or more activities completed by the end-user during the work schedule; and the one or more productivity scores for the end-user.

Additional features and advantages of the embodiments disclosed herein will be set forth in the detailed description that follows, and in part will be clear to those skilled in the art from that description or recognized by practicing the embodiments described herein, including the detailed description which follows, the claims, as well as the appended drawings.

Both the foregoing general description and the following detailed description present embodiments intended to provide an overview or framework for understanding the nature and character of the embodiments disclosed herein. The accompanying drawings are included to provide further understanding and are incorporated into and constitute a part of this specification. The drawings illustrate various embodiments of the disclosure, and together with the description explain the principles and operations thereof.

### BRIEF DESCRIPTION OF THE DRAWINGS

The features and advantages of the present disclosure will be more fully described in, or rendered obvious by the following detailed description of the preferred embodiments, which are to be considered together with the accompanying drawings wherein like numbers refer to like parts and further, wherein:

FIG. 1 is a block diagram of a computing system, in accordance with embodiments described herein;

FIG. 2 is a block diagram of an application program that is executable by the computing system of FIG. 1;

FIG. 3 is a block diagram of the application program in FIG. 2;

FIGS. 4A, 4B, and 4C are block diagrams showing the deployment of servers, in accordance with embodiments described herein;

FIG. 5 is a flowchart of a process carried out by the application program, in accordance with embodiments described herein;

FIG. 6 is a flowchart of a process carried out by the application program, in accordance with embodiments described herein;

FIG. 7 illustrates a graphical user interface showing the productivity scores and status dashboard for an end-user of the application program, in accordance with embodiments described herein;

FIG. 8 illustrates a graphical user interface showing the productivity scores and status dashboard for an end-user of the application program, in accordance with embodiments described herein;

FIG. 9 illustrates a graphical user interface showing the productivity scores and status dashboard for an end-user of the application program, in accordance with embodiments described herein; and

FIG. 10 illustrates a graphical user interface showing activity summary for an end-user of the application program, in accordance with embodiments described herein;

### DETAILED DESCRIPTION

Reference will now be made in detail to the present preferred embodiment(s), and examples of which is/are illustrated in the accompanying drawings. Whenever possible, the same reference numerals will be used throughout the drawings to refer to the same or like parts. Any specific details of the embodiments are used for demonstration purposes only, and no unnecessary limitations or inferences are to be understood therefrom.

Before describing in detail exemplary embodiments, it is noted that the embodiments reside primarily in combinations of components and procedures related to the system. Accordingly, the system components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

In this disclosure, the various embodiments may be a system, method, apparatus, and/or computer program product at any possible technical detail level of integration. A computer program product can include, among other things, a computer-readable storage medium having computer-readable program instructions thereon for causing a processor to carry out aspects of the present disclosure.

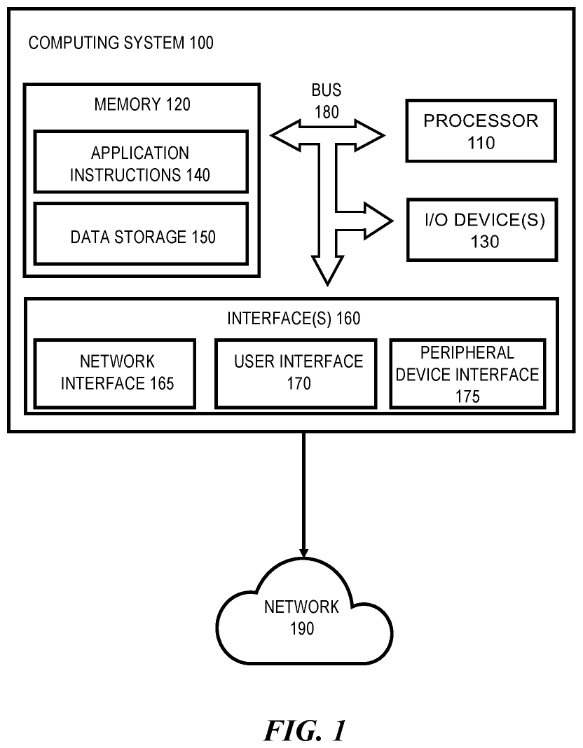

As shown in FIGS. 1-10, the embodiments in this disclosure relate to computer implemented systems and processes for evaluating the productivity of an application program user. In some embodiments, the system tracks the computer-related activities of an end-user, captures, classifies, indexes, and stores the data and information associated with the activities of the end-user, and produces a productivity score for the end-user for evaluation by an administrator, or admin-user. In some embodiments, the system transmits the data and information associated with the activities of the end-user to the administrator, and configures the data and information for display on a user-interface in a manner that is useful for a real-time evaluation the end-user's productivity and for an evaluation of the end-user for various periods of time (e.g., daily, monthly, yearly).

FIG. 1 illustrates an example of a computing system 100 that may be utilized to execute various procedures, including the processes described herein. The computing system 100 comprises a standalone computer or mobile computing device, a mainframe computer system, a workstation, a network computer, a desktop computer, a laptop, or the like. The computing system 100 can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive).

In some embodiments, the computing system 100 includes one or more processor(s) 110 coupled to a memory 120 through a system bus 180 that couples various system components, such as an input/output (I/O) device 130, to the processor 110. The bus 180 may be any of several types of bus structures including a memory bus or memory controller, a peripheral bus, and a local bus using any of a variety of bus architectures. For example, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, also known as Mezzanine bus.

In some embodiments, the computing system 100 includes one or more input/output (I/O) devices 130, such as video device(s) (e.g., a camera), audio device(s), and display(s) are in operable communication with the computing system 100. In some embodiments, similar I/O devices 130 may be separate from the computing system 100 and may interact with one or more nodes of the computing system 100 through a wired or wireless connection, such as over a network interface.

Processor 110 is suitable for the execution of computer readable program instructions include both general and special purpose microprocessors and any one or more processors of any digital computing device. For example, each processor 110 may be a single processing unit or a plurality of processing units, and may include a single or multiple computing units or multiple processing cores. The processor(s) 110 can be implemented as one or more microprocessors, microcomputers, microcontrollers, digital signal processors, central processing units, state machines, logic circuitries, and/or any devices that manipulate signals based on operational instructions. For example, the processor(s) 110 may be one or more hardware processors and/or logic circuits of any suitable type specifically programmed or configured to execute the algorithms and processes described herein. The processor(s) 110 can be configured to fetch and execute computer readable program instructions stored in the computer-readable media, which can program the processor(s) 110 to perform the functions described herein.

In this disclosure, the term “processor” can refer to substantially any computing processing unit or device, including single-core processors, single-processors with software multithreading execution capability, multi-core processors, multi-core processors with software multithreading execution capability, multi-core processors with hardware multithread technology, parallel platforms, and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures, such as molecular and quantum-dot based transistors, switches, and gates, to optimize space usage or enhance performance of user equipment. A processor can also be implemented as a combination of computing processing units.

In some embodiments, the memory 120 includes computer-readable application instructions 140, configured to implement certain embodiments described herein, and a database 150, comprising various data accessible by the application instructions 140. In some embodiments, the application instructions 140 include software elements corresponding to one or more of the various embodiments described herein. For example, application instructions 140 may be implemented in various embodiments using any desired programming language, scripting language, or combination of programming and/or scripting languages (e.g., C, C++, C#, JAVA, JAVASCRIPT, PERL, Angular, iOS, Android, etc.).

In this disclosure, terms “store,” “storage,” “data store,” data storage,” “database,” and substantially any other information storage component relevant to operation and functionality of a component are utilized to refer to “memory components,” which are entities embodied in a “memory,” or components comprising a memory. Those skilled in the art would appreciate that the memory and/or memory components described herein can be volatile memory, nonvolatile memory, or both volatile and nonvolatile memory. Nonvolatile memory can include, for example, read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM)). Volatile memory can include, for example, RAM, which can act as external cache memory. The memory and/or memory components of the systems or computer-implemented methods can include the foregoing or other suitable types of memory.

Generally, a computing device will also include, or be operatively coupled to receive data from or transfer data to, or both, one or more mass data storage devices; however, a computing device need not have such devices. The computer readable storage medium (or media) can be a tangible device that can retain and store instructions for use by an instruction execution device. The computer readable storage medium can be, for example, an electronic storage device, a magnetic storage device, an optical storage device, an electromagnetic storage device, a semiconductor storage device, or any suitable combination of the foregoing. A non-exhaustive list of more specific examples of the computer readable storage medium can include: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. In this disclosure, a computer readable storage medium is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

In some embodiments, the steps and actions of the application instructions 140 described herein are embodied directly in hardware, in a software module executed by a processor, or in a combination of the two. A software module may reside in RAM, flash memory, ROM memory, EPROM memory, EEPROM memory, registers, a hard disk, a removable disk, a CD-ROM, or any other form of storage medium known in the art. An exemplary storage medium may be coupled to the processor 110 such that the processor 110 can read information from, and write information to, the storage medium. In the alternative, the storage medium may be integrated into the processor 110. Further, in some embodiments, the processor 110 and the storage medium may reside in an Application Specific Integrated Circuit (ASIC). In the alternative, the processor and the storage medium may reside as discrete components in a computing device. Additionally, in some embodiments, the events or actions of a method or algorithm may reside as one or any combination or set of codes and instructions on a machine-readable medium or computer-readable medium, which may be incorporated into a computer program product.

In some embodiments, the application instructions 140 for carrying out operations of the present disclosure can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The application instructions 140 can execute entirely on the user's computer, partly on the user's computer, as a stand-alone software package, partly on the user's computer and partly on a remote computer, or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present disclosure.

In this disclosure, the term “user” refers to the end-user unless otherwise specified. System administrators and other persons having access to the system are referred to as “administrators” or “admin-users.” For example, in the context of the productivity management system and the application program 200 described herein, the system may analyze the activities and status changes of a particular employee (i.e., end-user) and the data and information derived from those activities and status changes may be reviewed, monitored, evaluated and/or analyzed by a supervisor of that particular employee (i.e., admin-user).

In some embodiments, the application instructions 140 can be downloaded to a computing/processing device from a computer readable storage medium, or to an external computer or external storage device via a network 190. A network adapter card or network interface in each computing/processing device receives computer readable program instructions from the network and forwards the computer readable application instructions 140 for storage in a computer readable storage medium within the respective computing/processing device.

In some embodiments, the computing system 100 includes one or more interfaces 160 that allow the computing system 100 to interact with other systems, devices, or computing environments. In some embodiments, the computing system 100 comprises a network interface 165 to communicate with a network 190. In some embodiments, the network interface 165 is configured to allow data to be exchanged between the computing system 100 and other devices attached to the network 190, such as other computer systems, or between nodes of the computing system 100. In various embodiments, the network interface 165 may support communication via wired or wireless general data networks, such as any suitable type of Ethernet network, for example, via telecommunications/telephony networks such as analog voice networks or digital fiber communications networks, via storage area networks such as Fiber Channel SANs, or via any other suitable type of network and/or protocol. Other interfaces include the user interface 170 and the peripheral device interface 175.

In some embodiments, the network 190 corresponds to a local area network (LAN), wide area network (WAN), the Internet, a direct peer-to-peer network (e.g., device to device Wi-Fi, Bluetooth, etc.), and/or an indirect peer-to-peer network (e.g., devices communicating through a server, router, or other network device). The network 190 can comprise copper transmission cables, optical transmission fibers, wireless transmission, routers, firewalls, switches, gateway computers and/or edge servers. The network 190 can represent a single network or multiple networks. In some embodiments, the network 190 used by the various devices of the computing system 100 is selected based on the proximity of the devices to one another or some other factor. For example, when a first user device and second user device are near each other (e.g., within a threshold distance, within direct communication range, etc.), the first user device may exchange data using a direct peer-to-peer network. But when the first user device and the second user device are not near each other, the first user device and the second user device may exchange data using a peer-to-peer network (e.g., the Internet).

Any connection between the components of the system may be associated with a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. As used herein, the terms “disk” and “disc” include compact disc (CD), laser disc, optical disc, digital versatile disc (DVD), floppy disk, and Blu-ray disc; in which “disks” usually reproduce data magnetically, and “discs” usually reproduce data optically with lasers. Combinations of the above should also be included within the scope of computer-readable media. In some embodiments, the computer-readable media includes volatile and nonvolatile memory and/or removable and non-removable media implemented in any type of technology for storage of information, such as computer-readable instructions, data structures, program modules, or other data. Such computer-readable media may include RAM, ROM, EEPROM, flash memory or other memory technology, optical storage, solid state storage, magnetic tape, magnetic disk storage, RAID storage systems, storage arrays, network attached storage, storage area networks, cloud storage, or any other medium that can be used to store the desired information and that can be accessed by a computing device. Depending on the configuration of the computing device, the computer-readable media may be a type of computer-readable storage media and/or a tangible non-transitory media to the extent that when mentioned, non-transitory computer-readable media exclude media such as energy, carrier signals, electromagnetic waves, and signals per se.

In some embodiments, the system is world-wide-web (www) based, and the network server is a web server delivering HTML, XML, etc., web pages to the computing devices. In other embodiments, a client-server architecture may be implemented, in which a network server executes enterprise and custom software, exchanging data with custom client applications running on the computing device.

In some embodiments, the system can also be implemented in cloud computing environments. In this context, “cloud computing” refers to a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

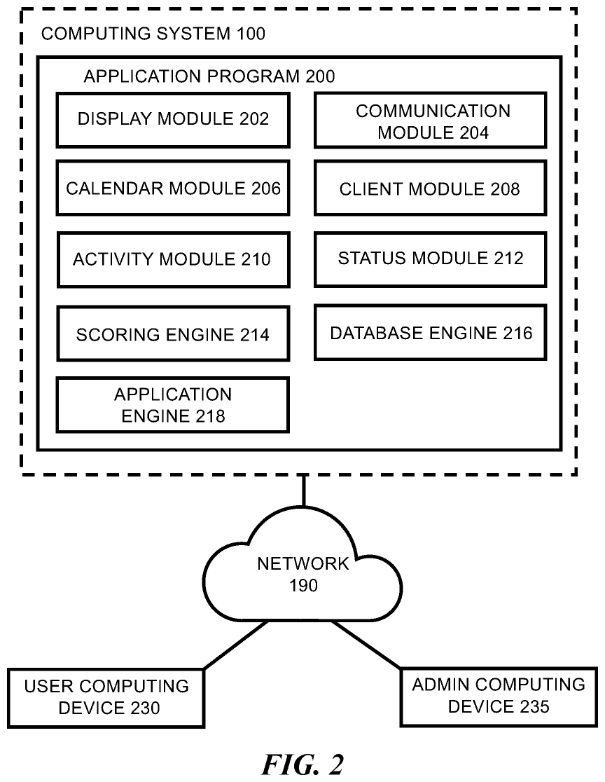

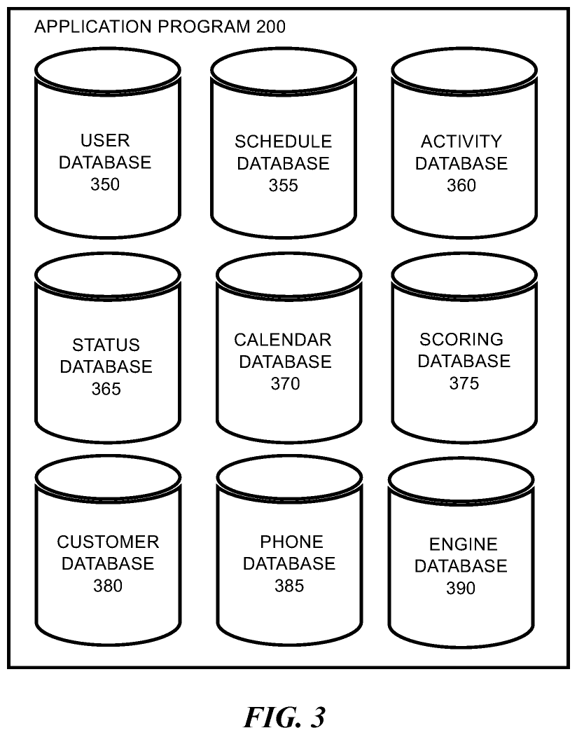

FIG. 2 and FIG. 3 illustrate an example computer architecture for the application program 200 described herein. FIG. 2 is block diagram showing the module and engine components needed to perform the various specific tasks within the computing system 100. In particular, FIG. 2 shows the components of the application program 200, which comprises a plurality of modules and engines configured to implement the processes and subprocesses of the productivity management system described herein. FIG. 3 is a block diagram showing the one or more databases utilized by the various modules and engines in FIG. 2.

FIG. 2 illustrates a block diagram of an application program 200, which provides the components utilized to implement the productivity management system described herein. In some embodiments, the application program 200 comprises one or more of a display module 202, communication module 204, calendar module 206, client module 208, activity module 210, status module 212, scoring engine 214, database engine 216, and application engine 218, each of which is configured to work and communicate with one another. As shown in FIG. 2 the application program 200 is in communication with, via the network 190, one or more user computing device(s), including the user (e.g., end-user) computing device 230 and/or administrator (“admin”) computing device 235.

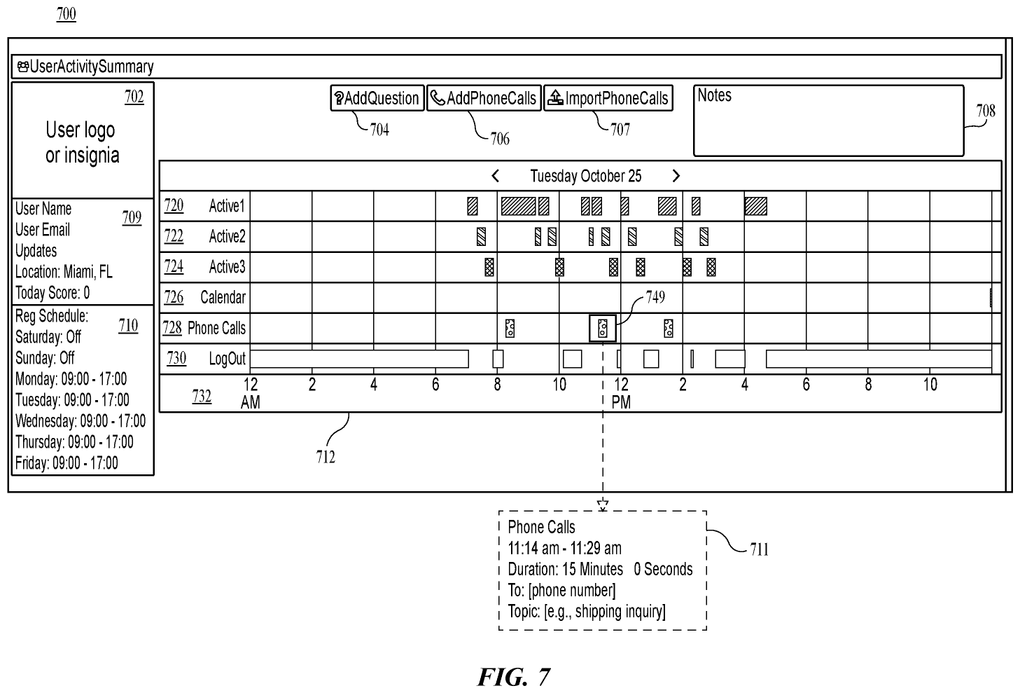

In some embodiments, the display module 202 contains the logic necessary to display one or more graphic user interfaces as shown in, for example, FIGS. 7-10. In some embodiments, the display module 202 is configured to temporarily generate and display various pieces of information in response to one or more commands or operations. The various pieces of information or data generated and displayed may be transiently generated and displayed, and the displayed content in the display module 202 may be refreshed and replaced with different content upon the receipt of different commands or operations. In some embodiments, the various pieces of information generated and displayed via the display module 202 may not be persistently stored. In some embodiments, the display module 202 is configured to generate a visualization of user identification information, user contact information, user activity or inactivity, user status, status changes, user schedule and calendar, user phone call log, user email log, user Internet activity, user logoff, pop-up windows with detailed information about specific data points, data tables, data charts, data summaries, action buttons (e.g., filter options, phone call log retrieval), etc. In some embodiments, the visualization further comprises a third-party insignia, contact information, charts, documents, and/or data that has been integrated into the displayed visualization.

In some embodiments, the communication module 204 contains the logic necessary to allow one or more users of the system to communicate with one another and further to allow the system to communicate with one or more end-users, admin-users, and/or third-party systems. In some embodiments, the communication module 204 provides mechanisms for synchronizing the information between and/or across one or more users and/or devices. For example, when the current status or status history for an end-user is updated based on one or more activities (or inactivity) inputted, captured, or otherwise obtained by the end-user's device, the communication module 204 can transmit the data and information associated with the one or more activities (or inactivity) to an admin-user's device to provide a real-time, or near real-time, report on the current status and updated status history for the end-user. In some embodiments, the communications module 204 is in communication with the client module 208 and is configured to associate communication identifiers (e.g., unique user ids) with a particular user and/or user device.

In some embodiments, the calendar module 206 contains the logic necessary to integrate the work schedule and non-work schedule for one or more users, for one or more predetermined periods (e.g., day, week, month, year), into the application program 200. The calendar module 206 is configured to manage all the data and information required for, or relevant to, the non-workdays in which the end-user will not be available to work or conduct their work duties, and therefore provide the data and information required to analyze and evaluate a end-user's activities and productivity over the one or more predetermined periods. The calendar module 206 is in communication with the display module 202, client module 208, and scoring engine 214, and communicates the data and information relevant to the analysis and display of a user's work and non-work schedule for a predetermined period.

In some embodiments, the client module 208 contains the logic necessary to implement the application program 200 in a third-party customer server 400 and/or user third-party computing device 230 using, for example, one or more servers or cloud computing environments.

In some embodiments, the activity module 210 contains the logic necessary to capture one or more computer-related activities executed or inputted by a user (e.g., entering data, clicking a webpage, entering or updating data and information into a system calendar, syncing information from a third party calendar, drafting or responding to an email, syncing information from a third party email system, attending to a telephone call on a telephone device that has been synced with the system, syncing information from a third party telephone system, syncing information from a third party database) and/or the absence of one or more computer-related activities executed or inputted by the user (inactivity) for a predetermined period (e.g., day, week, month, year). The respective data and information for the one or more computer-related activities can include a plurality of components. For example, the data and information associated with a telephone call can include the phone number, the party (e.g., vendor, customer, driver, unrelated person), and any notes inputted by the user (e.g., purpose of the call). In some embodiments, each respective activity is characterized (e.g., description of activity, date, and time), indexed, and stored as an activity log associated with the user. The activity module 210 is in communication with the display module 202 and provides the data and information relevant to displaying and/or comparing a user's activities over a span of one or more predetermined periods. In some embodiments, each activity for a user is displayed so an admin-user can review the activities executed or inputted by the user in real-time.

In some embodiments, the activity module 210 contains the logic necessary to capture one or more employment-related tasks that are started and/or completed by an end-user. In some embodiments, for example, the one or more employment-related tasks can include attending to or processing accounting information (e.g., payables, receivables), factoring, fuel card management, insurance claims management, property maintenance records, compliance records, expiration alerts, set-up and tracking of property (e.g., trucks), global positioning system (GPS), electronic logbook device (ELD), cargo loads, etc. In this context, the attending to or processing of information includes entering data, acquiring data (e.g., downloading), requesting data (e.g., pulling via API or FTP), accumulating data from multiple third parties, accumulating data from internal users (e.g., accounting, legal, insurance, logistics, service, etc.).

In some embodiments, the status module 212 contains the logic necessary to classify and index the end-user activity into one or more status categories. In some embodiments, the activity module 210 is configured to manage each activity on a micro level and the status module 212 is configured to manage the activities on a macro level. For example, in some embodiments, the activity module 210 captures each of the computer-related activities executed or inputted by a user (e.g., user clicked through several webpages) and communicates with the display module 202 to display the data and information relevant to each of the user's activities for a predetermined period (e.g., each webpage visited over an hour is listed in a table), whereas the status module 212 classifies and indexes the user's activities into one or more status categories that can be displayed as a dashboard (e.g., user was active for an hour). The status module 212 is in communication with the activity module 210 and the display module 202 and provides the data and information relevant to the display of a user's status and status history for a predetermined period. In some embodiments, one or more status categories for a user are displayed so an admin-user can, in real-time, review the status of the user.

In some embodiments, the scoring engine 214 is configured to accumulate the data and information associated with the one or more computer-related activities executed or inputted by a user (including, for example, the duration of each activity), the one or more status categories (including, for example, the duration of each status), the work schedule and non-work schedule for the user (including, for example, the days and hours of each respective day the user should be conducting the one or more computer-related activities), the calendar (including, for example, sick days and vacation days), and the activity and status histories spanning a predetermined period for the user. In some embodiments, the scoring engine 214 contains the logic necessary to convert the accumulated data and information for the user, over one or more predetermined periods, into a score (e.g., current score) that can represent an objective evaluation of the user's productivity for a specified period (e.g., day, month), and further to compare the current score against various historical scores for the specific end-user, a different end-user, or one or more groups of users. In some embodiments, for example, the scoring engine 214 can aggregate the time spent on specific user activities into a total amount and, based on the number of hours the user was scheduled to work, calculate the percentage of time (per hour, per day, etc.) the user spent on the activities relative to the user's work schedule. Such a metric provides an objective method of scoring the performance of a user relative to other, similarly situated users.

In some embodiments, the database engine 216 is configured to facilitate the storage, management, and retrieval of data to and from one or more storage mediums, such as the one or more internal databases 350, 355, 360, 365, 370, 375, 380, 385, and 390 shown in FIG. 3. In some embodiments, the database engine 216 is configured as an in-process get, set, and update mechanism coupled to various sources, including, for example, volatile, in-process, or shared memory (e.g., RAM; application state). In some embodiments, the database engine 216 is configured with get, set, and update functions to call for an application programming interface (API) (e.g., a HTTP request) to interact with data stored on external web servers (e.g., cloud or private servers). In some embodiments, the database engine 216 is configured with get, set, and update functions to interact with data stored on attached non-volatile storage including, for example, a hard drive. In some embodiments, the database engine 216 is coupled to an external storage system including, for example, a USB-connected storage device. In some embodiments, the database engine 216 is configured to apply changes to one or more databases. In some embodiments, the database engine 216 comprises a search engine component for searching through thousands of data sources stored in different locations.

In some embodiments, the application engine 218 is configured to deploy the application program 200 to one or more servers. In some embodiments, one or more of the respective servers is in the cloud. In some embodiments, one or more of the respective servers is a private server.

As shown in FIG. 3, a plurality of databases is included in the application program 200 and each database is in communication with the various components in the application program 200 via the database engine 216. In some embodiments, for example, the application program 200 comprises a combination, or subcombination, of the following databases: a user database 350, a schedule database 355, an activity database 360, a status database 365, a calendar database 370, a scoring database 375, a customer database 380, a phone database 385, and an engine database 390.

In some embodiments, the user database 350 retrievably stores the data and information associated with a user of the system, including their e-mail address, unique user ID, session-derived data, account credentials (e.g., username, telephone number, password), and/or any other information relevant to the usage of the application program 200. In some embodiments, the user database 350 stores the data related to user-sessions, including, for example, diagnostic and/or system metadata (e.g., error and event logs), usage and activity data (e.g., websites viewed, hyperlinks clicked, phone calls, log-off, etc.), system and session performance data (e.g., memory utilization, etc.), and pending and past productivity scores. In some embodiments, the user database 350 stores the data related to user personalization and preferences (e.g., system-inferred settings). In some embodiments, user settings and preferences, including system-defined or system-inferred customizations, may be utilized by one or more modules of the application program 200.

In some embodiments, the activity database 360 retrievably stores the information and data related to the user activities that will be captured, indexed, stored, analyzed, and displayed by the application program 200. In some embodiments, the user activities include, e.g., websites viewed, hyperlinks clicked, phone calls, log-off, etc. The user activity data may be utilized by one or more modules of the application program 200, including, for example, the activity module 210, the status module 212, the scoring engine 214, the display module 202, and the database engine 216.

In some embodiments, the status database 365 retrievably stores the information and data related to the status categories that will be created, indexed, stored, analyzed, and displayed by the application program 200. In some embodiments, the status categories can include active, inactive, calendar, phone call, and logout. In some embodiments, the status categories can include first active, second active, third active, etc., whereby each respective active category is defined by the admin-user to capture overlapping or non-overlapping information. For example, the first active category can include the subject matter, start time, stop time, and duration for each of one or more computer-related activities, such as user-inputted or user-selected websites in an Internet browser; the second active category can be defined to include a sub-set of activities in the first active category or it can be defined to include a period of inactivity (e.g., 5 minutes) in which the end-user has not completed any activities; and the third active status category can be defined as a sub-set of activities in the first and/or second active categories or it can be defined to include a second period of inactivity (e.g., 15 minutes) in which the end-user has not completed any activities. In various embodiments, the status categories can be defined or customized for a particular client or user.

In some embodiments, the calendar database 370 retrievably stores the information and data related to user work schedules and non-work schedules. In some embodiments, the data and information is associated with one or more predetermined periods (e.g., day, week, month, year) for each work and non-work schedule. In some embodiments, the calendar database 365 comprises an archived history of all work and non-work schedules entered into the application program 200 for a specific user or a client. As such, a user can retrieve information needed to analyze and evaluate another user's productivity over a predetermined period.

In some embodiments, the scoring database 375 retrievably stores information and data related to the one or more productivity scores calculated for one or more users and/or customers and associated users thereof, that utilize or have utilized the application program 200. In some embodiments, the information and data includes the various scores, the period (e.g., last month, last 12 months, total) for which the scores apply, and/or the methods in which the scores were calculated.

In some embodiments, the customer database 380 retrievably stores information and data related to customers/clients of the administer (e.g., business or person) managing the application program 200. For example, if there is a client using the application program 200, the customer database 380 stores the information and data associated with that specific client, including a roster of the end-users and admin-users associated with the client, as well as the historical information associated with that specific client.

In some embodiments, the phone database 385 retrievably stores information and data related to user phone calls. In such embodiments, the user's landline phone, mobile phone, voiceover IP phone, etc. has been configured to communicate (i.e., transmit information) with the user computing device 230.

In some embodiments, the engine database 390 retrievably stores information and data related to the deployment of the application program 200. In some embodiments, the output commands and logic stored in the engine database 390 are utilized throughout the computing system 100.

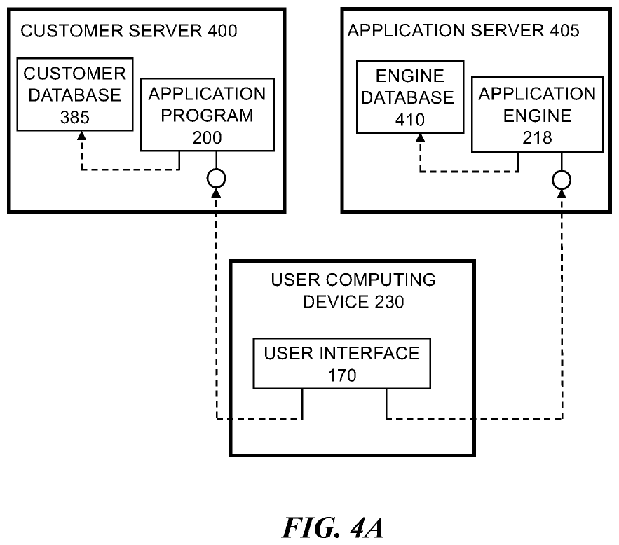

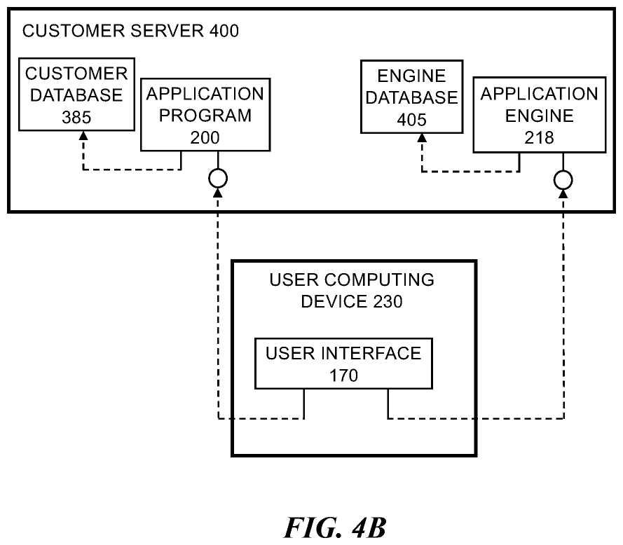

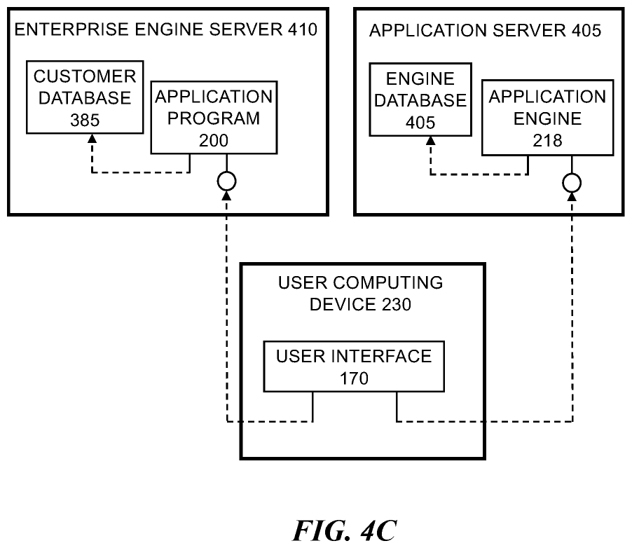

FIGS. 4A, 4B, and 4C illustrate embodiments for the deployment of servers involved with the application program 200. In some embodiments, as shown in FIG. 4A, the customer data is stored on the customer's server space 400, and the application engine 218 is hosted on the application server space 405. Both the customer server space 400 and the application server space 405 can be in the cloud or on private servers. In some embodiments, as shown in FIG. 4B, the customer's server space 400 holds both the application program 200 and the application engine 218. In some embodiments, as shown in FIG. 4C, the customer accesses the application program 200 hosted on the enterprise engine server space 410, and the application engine 218 is hosted on the application server space 405.

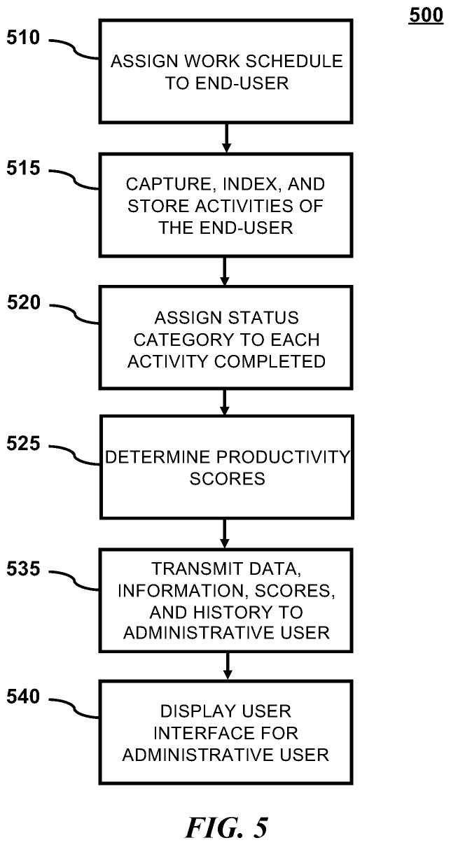

FIG. 5 illustrates a computer-implemented process, or software, 500 for an exemplary embodiment of this disclosure. In some embodiments, the process 500 comprises a plurality of steps, including the assignment of a work schedule to an end-user 510; capturing, indexing, and storing one or more activities executed by the end-user 515 or inputted by the end-user 515 or another user; assigning a status category to each of the one or more activities started, engaged with, or completed 520; calculating a productivity score for the end-user 525; transmitting the data, information, productivity scores, and associated computer-related data history to an admin-user 535; and displaying one or more productivity scores and an activity summary for an end-user 540, as shown, e.g., in FIGS. 7-10.

In some embodiments, the process 500 comprises the step 510 of assigning a work schedule to an end-user. In some embodiments, step 510 comprises the import or input of the end-user's work schedule, which defines the days and hours of the respective days that the end-user should be logged into the user computing device 230. Once the data and information associated with the end-user's work schedule has been stored into one or more databases, such as the user database 350, schedule database 355, and customer database 380, the work schedule for the end-user can be transmitted to the admin computing device 235 for display on a user interface. For example, the user-interface 700 shown in FIG. 7 shows the work schedule 710.

In some embodiments, the process 500 comprises the step 515 of capturing, indexing, and storing one or more activities executed or inputted (i.e., entered) by the end-user (or another user on behalf of the end-user). In some embodiments, step 515 comprises the capturing of any actions on the user computing device 230 or on any devices associated with the user computing device 230, including one or more phones or mobile devices.

In some embodiments, the process 500 comprises the step 520 of assigning a status category to each of the respective activities captured on the user computing device 230. In some embodiments, the status categories include first active, second active, third active, phone calls, and logout. In some embodiments, the particular status categories can be defined by an admin user. For example, the first active status can be defined as the time used for one or more activities, the second active status can be defined as the time not used for an activity, such as a brief period (e.g., 5 minutes), and the third active status can be defined as a longer period of inactivity (e.g., 15 minutes). The status categories for each activity can be transmitted to the admin computing device 235 for display on a user interface. For example, the user-interface 700 shown in FIGS. 7-9 show the following status categories: first active 720, second active 722, third active 724, calendar 726, phone calls 728, and logout 730. In some embodiments, the one or more status categories are displayed on the admin computing device 235 as a dashboard having each status category independently displayed horizontally across the display. To assist the admin-user evaluate the activities of the end-user, the footer 732 having a timeline is provided. In some embodiments, a summary table 734 having all of the status categories shown in sequence is provided. In some embodiments, the summary table 734 includes the timeline.

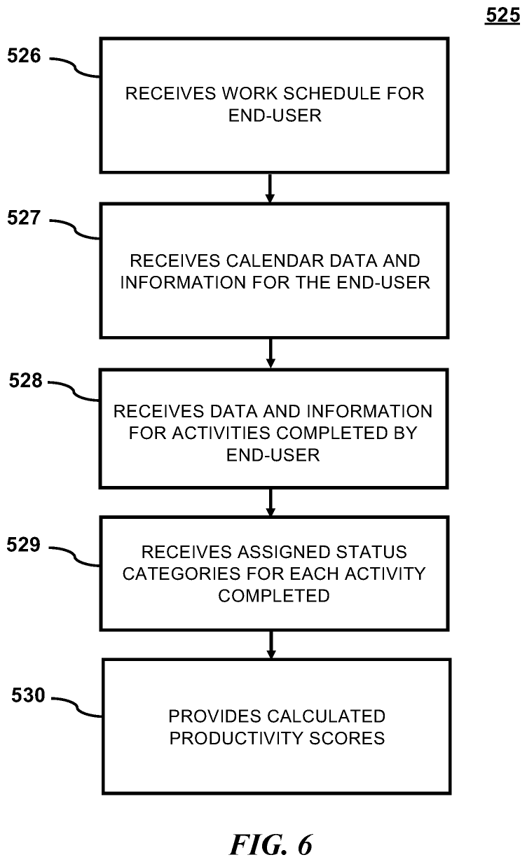

In some embodiments, the process 500 comprises the step 525 of determining one or more productivity scores for the end-user. As shown in FIG. 6, the step 525 can comprise a plurality of substeps to determine the one or more productivity scores for the end-user. For example, in some embodiments, the step 525 comprises the substep 526 of receiving the work schedule for the end user (e.g., 8 hours (480 minutes) daily, 40 hours (2400 minutes) weekly, 80 hours (4800 minutes) biweekly, etc.). In some embodiments, the work schedule for the end user accounts for the breaks taken by the end-user (e.g., 15-minute breaks, 30-minute lunch breaks, etc.) and determines the total time (hours, minutes) of the work schedule that is expected work time for the end-user (e.g., subtract two 15-minute breaks and one 30-minute break from the 8-hour (480 minutes) workday=7 hours (420 minutes)). In some embodiments, the work schedule for the end user does not account for the breaks taken by the end-user. In such embodiments, any breaks taken by the end-user are accounted for in substep 530.

In some embodiments, the process 500 comprises the substep 527 of receiving the calendar information for the end-user. In some embodiments, the calendar information includes the one or more days in the work schedule in which the end-user has scheduled or has been scheduled for non-worktime (e.g., vacation days, sick days, travel days, training days), that is, the days in which the end-user would normally or otherwise be scheduled to be using the user computing device 230.

In some embodiments, the step 525 comprises the substep 528 of receiving the data and information for the activities executed or inputted by the end-user on the user computing device 230 during the work schedule. In such embodiments, the activity module 210, which contains the logic necessary to capture one or more employment-related tasks that are started and/or completed by an end-user, is utilized to capture any input (e.g., keystroke, mouse click) or absence of activity for the end-user during the work schedule.

In some embodiments, the step 525 comprises the substep 529 of receiving the data and information for the status categories assigned to each of the respective activities. After the data and information for each activity executed or inputted by the end-user on the user computing device 230 is captured and then received in substep 528, the status module 212 categorizes each captured activity into one or more status categories. For example, activities directed to the end-user's employee duties, such as entering data, sending email communications, attending to telephone calls with customers, etc., can be categorized as Active 1 status. A first predetermined period of inactivity (e.g., 5-minutes, 10-minutes, 15-minutes), which may be common for one or more end-users depending on their work duties, can be categorized as Active 2 status. A second predetermined period of inactivity (e.g., 20-minutes, 25-minutes, 30-minutes), which may be uncommon for the one or more end-users depending on their work duties, can be categorized as Active 3 status. After one or more activities are assigned to one or more status categories, the data and information associated with the activities and status categories is received in the substep 529.

In some embodiments, the step 525 comprises the substep 530, which provides one or more productivity scores that are calculated using the data and information received in substeps 526-529. The one or more productivity scores can be defined according to one or more admin-user preferences. For example, for each end-user, the substep 530 can provide a productivity score for a day, week, month, quarter, year, etc.

In some embodiments, for example, the productivity score is based on the amount (or fraction or percent) of time an end-user spent working on one or more activities relative to the total amount of time provided on the work schedule for a predetermined period (e.g., 480 minutes, 2400 minutes). For example, in some embodiments, each of the one or more activities is associated with a specific status category (e.g., Active 1, A1) and the productivity score (PS) is based on time spent in Active 1 divided by total time (T) the end-user was scheduled to work. In such embodiments, PS=A1/T.

In some embodiments, the periods of inactivity are assigned to a specific status category (e.g., a 15-minute break is Active 2 status category). In some embodiments, for example, the productivity score (PS) is based on the amount of time an end-user spent working on activities categorized as Active 1 status (A1) minus the amount of time the end-user spent in the inactive period categorized as Active 2 status (A2) for a predetermined period. In such embodiments, PS=(A1−A2)/T.

In some embodiments, for example, the productivity score is based on the amount of time an end-user spent working on activities categorized as Active 1 status minus a predefined period (e.g., 15 minutes) for each occurrence the end-user was inactive and in the Active 2 status. For example, if the end-user was inactive for 18 minutes and the system categorized that period as Active 2, then the productivity score (PS) would be based on the total time spent in Active 1 status (A1) minus 15 minutes for that occurrence of Active 2 status (A2) and 15 minutes for each additional occurrence of Active 2 status. In such embodiments, PS=[A1−(A2)n]/T, and n is the number of occurrences the end-user switched from the A1 to A2 status category.

In some embodiments, the productivity score is a weighted productivity score based on the relative amounts of time the end-user spent in, for example, Active 1 status, Active 2 status, and Active 3 status. In such embodiments, different weights of importance are assigned to each status category when calculating the weighted productivity score. For example, the weighted productivity score can add the amount of time in Active 1 status, Active 2 status, and Active 3 status, whereby each status category is multiplied by a coefficient factor that adjusts the productivity score based on the relative importance of each status category. In such embodiments, for a predetermined period, PS=(A1)x+(A2)y+(A3)z, where x, y, and z are predetermined coefficient factors; or PS=(A1)x+(A2)y, where x and y are predetermined coefficient factors. For example, the coefficients x, y, and z can be independently defined as a number in the range of 0.1 to 10; 0.1 to 5.0; 0.1 to 1.0; etc.

In some embodiments, the total time provided by the work schedule does not account for any required periods of inactivity, such as the breaks an end-user is expected to take (e.g., two 15-minute breaks and one 30-minute break). In such embodiments, for an 8-hour workday (480 minutes), each break would be considered a period of inactivity and categorized as Active 2 status, and T=480 minutes.

In some embodiments, the total time provided by the work schedule accounts for any required periods of inactivity. For example, if two 15-minute breaks and one 30-minute break are required by law or company policy, then an 8-hour workday (480 minutes) can be redefined as a 7-hour workday (480−15−15−30=420 minutes). In such embodiments, the work breaks are accounted for, and T=420 minutes. In such embodiments, each of the breaks would be excluded from the Active 2 status, and only further periods of inactivity would be captured and categorized as Active 2 status.

In some embodiments, the productivity score for a particular end-user is a relative productivity score, meaning the productivity score is based on an evaluation of a plurality of similarly situated end-users (e.g., a call center having dozens of employees who have the same duties) and adjusted to account for circumstances specific to the plurality of similarly situated end-users. In such embodiments, the relative productivity score provides a pre-specified distribution having specific mean and derivation properties.

In some embodiments, the productivity score can be displayed as a percentage of time an end-user spent working in Active 1 status. In some embodiments, the percentage can be converted into a productivity grade (e.g., A, B, C, D, F, in which, e.g., A=380+ minutes; B=320-379 minutes; C=280-319 minutes; D=220-279 minutes; and F=219 or less minutes based on a total time of 420 minutes) and the productivity grade can be displayed as the productivity score.

In some embodiments, as shown in FIG. 5, the process 500 comprises the step 535 of transmitting the data and information received and obtained in the step 525 to the admin-user computing device 235. In some embodiments, the process 500 comprises the step 540 of displaying the data and information, including the work schedule, productivity score, activities, and status categories on a user interface on the admin-user computing device 235. Exemplary embodiments of the user interface on the admin-user computing device 235 are shown in FIGS. 7-10.

As shown in FIGS. 7-9, for example, the user interface 700 includes a productivity score in the summary 709. In the example, the summary 709 includes one or more of a daily score (“Today Score”), an overall score (“Overall Score”) and/or a monthly score (“Last Month Score”) for the current and/or previous month (i.e., the last month relative to the current day of viewing). In some embodiments, the overall score is defined to cover a period from when the end-user started using the user computing device 230, or a lesser period of use, such as a year, quarter year, month, week, day, etc.

In various embodiments, additional features of the application program 200 are shown in the graphic user interfaces in FIGS. 7-10. In some embodiments, as shown in user interface 700 in FIG. 7, the display module 202 contains the logic necessary to display third party identifying information 702, which includes the name and/or logo of the third party. In some embodiments, the display module 202 contains the logic necessary to display the work schedule 710 for an end-user. In some embodiments, the display module 202 and communication module 204 include the logic necessary for a user to manually input information related to the activities or status categories, or to ask another user a question. For example, as shown in user interface 700 in FIG. 7, the display includes the notepad 708 where a user can enter or read notes, the action button 704, which will prompt the user to ask a question (e.g., admin-user requesting information from end-user), the action button 706, which will prompt the user to enter phone call information, and the action button 707, which will prompt the retrieval of a phone call log (e.g., import the phone call log from a third-party system, database, and/or server).

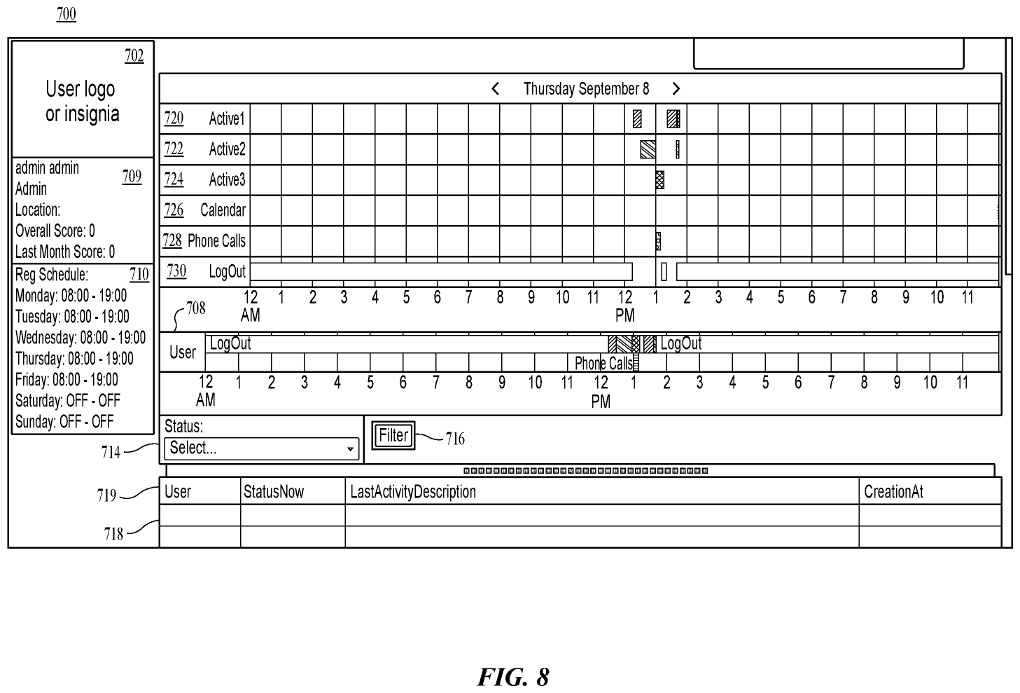

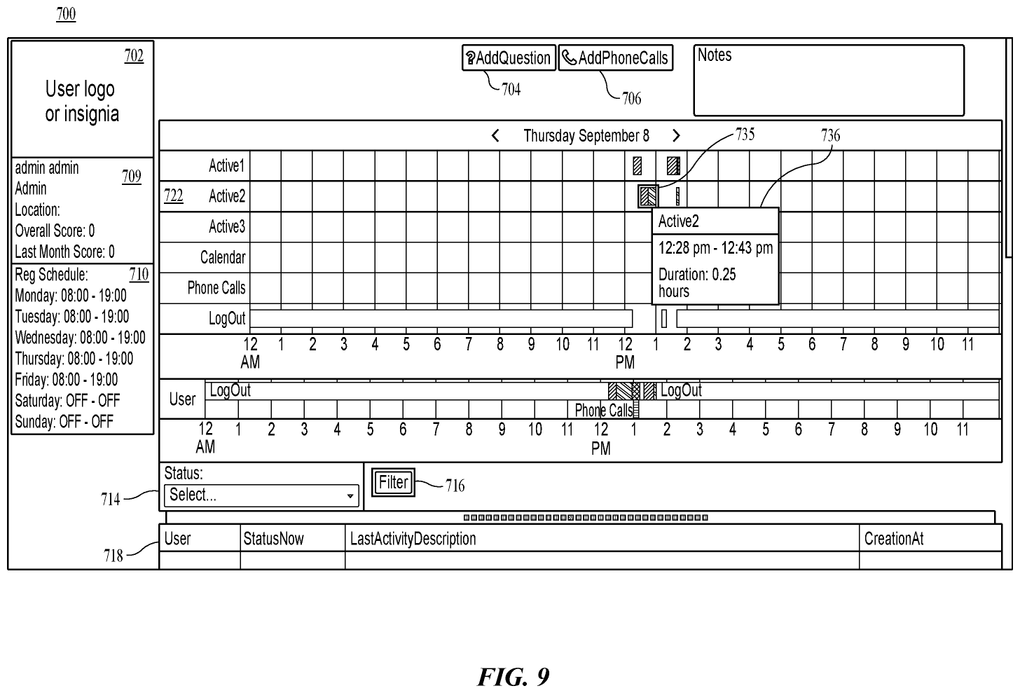

In some embodiments, the display module 202 contains the logic for displaying the status dashboard 712. In some embodiments, as shown in the user interface 700 in FIG. 8, the status dashboard 712 comprises one or more status categories, such as first active 720 (Active1), second active 722 (Active2), third active 724 (Active3), calendar 726, phone calls 728, and logout 730. In some embodiments, after each activity is indexed into a status category, the duration of that activity is displayed in the appropriate status and the relevant information can be called up by the user by hovering the user's computer cursor over the activity. For example, as shown in user interface 700 in FIG. 9, the activities 735 of the user classified in status category 722 (labeled “Active2”) are displayed in a horizontal view within the status dashboard 712; and, when the cursor is positioned (via a user-controlled device, such as a keyboard or mouse) over the activities 735, the information box 736 appears on the display. In such embodiments, the information box 736 comprises further information about the activity 735, including the start time, the stop time, and the duration for the activity 735. In some embodiments, after a phone call has been indexed and displayed in the category for phone calls 728, the user can obtain further details. As shown in FIG. 7, for example, the information for the phone call 749 can be retrieved and displayed in the information box 711. The information for the specific phone call 749 can include the start time, finish time, duration, phone number, and topic or purpose of the phone call 749.

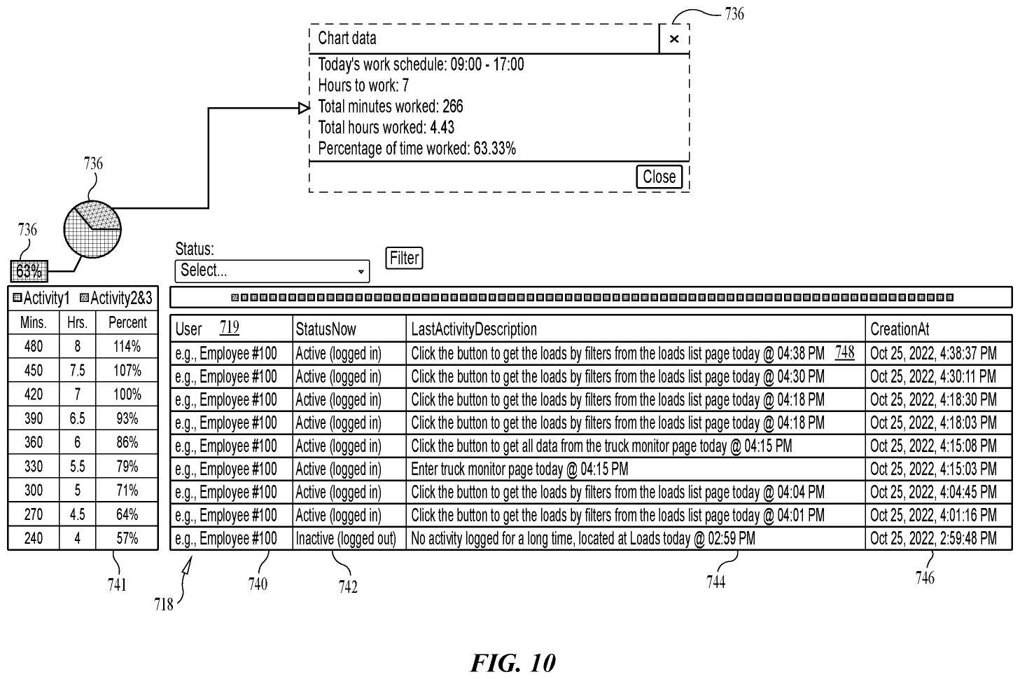

In some embodiments, the display module 202 contains the logic for displaying the activity summary 718. In some embodiments, as shown in FIGS. 8-10, the user interface includes the activity summary 718 displayed below the status dashboard 712. In some embodiments, the activity summary 718 includes various identifying information for each activity captured by the application program 200. For example, FIG. 8 shows the header 719 at the top of the activity summary 718. The header 719 can include any suitable labels for the columns of information, including, for example, user, status category, activity and description, and entry time and date. The columns of information can include any level of detail. In some embodiments, in the example, the activity summary 718 further includes the columns of information, such as user 740, status category 742, activity (and description) 744, and entry date and time 746. In some embodiments, each of the activities displayed in the activity summary 718 correspond to one or more status categories, which are displayed in column 742 and in the status dashboard 712. For example, the activity 748 in the activity summary 718 (FIG. 10) is an entry for a phone call and that activity entry is shown as bar 749 (FIG. 7) in the status dashboard 712.

In some embodiments, the display module 202 contains the logic for displaying the productivity score for an end-user in different formats. In FIG. 10, for example, the activities summarized in the status dashboard 712 and/or the activities listed in the activity summary 718 can be aggregated, summarized, and displayed in a pie chart, such as the chart 743. In such embodiments, the chart 743 illustrates the ratio between two data points. In this example, the first data point includes the amount of time the end-user spent on activities classified in the first active status 720 relative to the amount of time the end-user spent in the second active status 722 and the third active status 724 (combined). In the example, the end-user spent 63% of their scheduled work time performing activities that qualify in the first active status 720, and the specific number (63) is displayed in the information box 745. In some embodiments, the display module 202 contains the logic for displaying detailed information about the data summarized in the chart 743. For example, in some embodiments, the user can prompt the display of the information box 747 as shown in FIG. 10. In such embodiments, the information box 747 displays specific details related to the specific number (63) is displayed in the information box 745, including the end-user's daily work schedule, working hours (total hours less breaks), total minutes worked, total hours worked, and the percentage of time executing activities that fall within the definition of the first active status 720.

In various embodiments, the system, program, and methods described herein for obtaining one or more productivity scores and an activity summary for an end-user provides advantages over existing programs. After capturing the activity or inactivity of an end-user, the system, program, and methods described herein classify each captured activity into one or more status categories that can be displayed in a dashboard for an admin-user to review. The system, program, and methods described herein further display each of captured activities in a summary table for a more detailed understanding of the activity or inactivity of the end-user. The system, program, and methods described herein further calculate one or more productivity scores for the end-user based on the data and information obtained from the activities and status categories. The one or more productivity scores are displayed on the user interface and allow an admin-user an objective way to evaluate an end-user. The one or more productivity scores can include an evaluation of an end-user with respect to one or more periods of the end-user's historical production, with respect to the production of one or more different end-users over one or more periods of time, and/or with respect to a total historical evaluation of all end-users evaluated for one or more periods of time.

In this disclosure, the various embodiments are described with reference to the flowchart illustrations and/or block diagrams of methods, apparatus (systems), and computer program products. Those skilled in the art would understand that each block of the flowchart illustrations and/or block diagrams, and combinations of blocks in the flowchart illustrations and/or block diagrams, can be implemented by computer readable program instructions. The computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions or acts specified in the flowchart and/or block diagram block or blocks. The computer readable program instructions can be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions can be loaded onto a computer, other programmable data processing apparatus, or other device to cause a series of operational acts to be performed on the computer, other programmable apparatus, or other device to produce a computer implemented process, such that the instructions that execute on the computer, other programmable apparatus, or other device implement the functions or acts specified in the flowchart and/or block diagram block or blocks.

In this disclosure, the flowchart and block diagrams in the figures illustrate the architecture, functionality, and operation of possible implementations of systems, methods, and computer program products according to the various embodiments. Each block in the flowchart or block diagrams can represent a module, segment, or portion of instructions, which comprises one or more executable instructions for implementing the specified logical function(s). In some embodiments, the logic and functions of two or more modules can be combined into a single module. In some embodiments, the functions noted in the blocks can occur out of the order noted in the Figures. For example, two blocks shown in succession can, in fact, be executed concurrently or substantially concurrently, or the blocks can sometimes be executed in the reverse order, depending upon the functionality involved. In some embodiments, each block of the block diagrams and/or flowchart illustration, and combinations of blocks in the block diagrams and/or flowchart illustration, can be implemented by a special purpose hardware-based system that performs the specified functions or acts or carry out combinations of special purpose hardware and computer instructions.

In this disclosure, the subject matter has been described in the general context of computer-executable instructions of a computer program product running on a computer or computers, and those skilled in the art would recognize that this disclosure can be implemented in combination with other program modules. Generally, program modules include routines, programs, components, data structures, etc. that perform particular tasks and/or implement particular abstract data types. Those skilled in the art would appreciate that the computer-implemented methods disclosed herein can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated embodiments can be practiced in distributed computing environments where tasks are performed by remote processing devices that are linked through a communications network. Some embodiments of this disclosure can be practiced on a stand-alone computer. In a distributed computing environment, program modules can be located in both local and remote memory storage devices.

As used herein, the term “add-on” (or “plug-in”) refers to computing instructions configured to extend the functionality of a computer program, where the add-on is developed specifically for the computer program. The term “add-on data” refers to data included with, generated by, or organized by an add-on. Computer programs can include computing instructions or an application programming interface (API) configured for communication between the computer program and an add-on. For example, a computer program can be configured to look in a specific directory for add-ons developed for the specific computer program. To add an add-on to a computer program, for example, a user can download the add-on from a website and install the add-on in an appropriate directory on the user's computer.

In this disclosure, the terms “component,” “system,” “platform,” “interface,” and the like, can refer to and/or include a computer-related entity or an entity related to an operational machine with one or more specific functionalities. The disclosed entities can be hardware, a combination of hardware and software, software, or software in execution. For example, a component can be a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As another example, a component can be an apparatus that provides specific functionality through electronic components without mechanical parts, wherein the electronic components can include a processor or other means to execute software or firmware that confers at least in part the functionality of the electronic components. In some embodiments, a component can emulate an electronic component via a virtual machine, e.g., within a cloud computing system.

In this disclosure, the descriptions of the various embodiments have been presented for purposes of illustration and are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein. Thus, the appended claims should be construed broadly, to include other variants and embodiments, which may be made by those skilled in the art.

I/We claim:

1. A computer implemented method for obtaining one or more productivity scores and an activity summary for an end-user of an application program, comprising:
providing the application program for carrying out the method;
assigning a work schedule to the end-user, the work schedule comprising a first list of days and hours for each of the respective days in which the end-user should be using the application program;
indexing and storing data and information in a database for one or more activities completed by the end-user during the work schedule, wherein the data and information comprises a description, a start time, an end time, and a duration for each respective activity of the one or more activities;
assigning each respective activity to one or more status categories, the one or more status categories comprising first active, second active, phone calls, and logout;
calculating one or more productivity scores for the end-user, the one or more productivity scores comprising a current month score spanning from an first selected day of a current month to a second selected day of the current month, wherein the calculating is based on the duration for the one or more activities in the first active status category and the first list of days and hours in the work schedule for the current month;
transmitting the indexed and stored data and information for the one or more activities, the one or more status categories assigned to each of the one or more activities, and the one or more productivity scores to an administrator of the application program; and
displaying a user interface for the administrator, the user interface comprising:
the activity summary, comprising a chronological history for each of the one or more status categories, wherein the chronological history includes at least a portion of the work schedule;
a first register comprising each of the one or more activities completed by the end-user during the work schedule, the one or more status categories assigned to each respective activity of the one or more activities completed by the end-user during the work schedule, and the description of each respective activity of the one or more activities completed by the end-user during the work schedule; and
the one or more productivity scores for the end-user.

2. The computer implemented method of claim 1, wherein the one or more activities comprises website visited, hyperlink clicked, phone call, application program log-in, application program log-off, and inactivity.

3. The computer implemented method of claim 2, wherein the first active status category comprises website visited, hyperlink clicked, and application program login.

4. The computer implemented method of claim 2, wherein the second active status category comprises inactivity, wherein the inactivity is defined by a first predetermined period in which the end-user is not engaged in another activity of the one or more activities.

5. The computer implemented method of claim 4, wherein the one or more status categories further comprises a third active;
wherein the third active status category comprises inactivity;
wherein the inactivity is defined by a second predetermined period in which the end-user is not engaged in another activity of the one or more activities; and
wherein the second predetermined period is greater than the first predetermined period.

6. The computer implemented method of claim 1, wherein the one or more status categories further comprises a calendar;
wherein the calendar comprises a second list of days and hours for each of the respective days in which the end-user should not be using the application program.

7. The computer implemented method of claim 2, wherein the application program log-off is defined by an end-user instruction to end access to the application program.

8. The computer implemented method of claim 1, wherein the one or more productivity scores further comprises a total score spanning from the first selected day of an initial month to the second selected day of the current month, the initial day being when the end-user started using the application program, wherein the calculating is based on the duration for the one or more end-user activities in the first active status category and the first list of days and hours in the work schedule for each month since the initial month.

9. The computer implemented method of claim 1, wherein the user interface further comprises a text input window for inputting a question to the end-user, and a first call-to-action button for transmitting the question to the end-user.

10. The computer implemented method of claim 1, wherein the user interface further comprises a text input window for inputting a phone call record, and a second call-to-action button for transmitting the phone call record to the database.

11. The computer implemented method of claim 10, wherein the phone call comprises data and information including telephone number, telephone contact, duration of phone call, and optionally, notes about the phone call.

12. The computer implemented method of claim 1, wherein the user interface further comprises a drop-down menu for selecting a specific status category and a third call-to-action button for displaying a second register comprised of only the specific status category selected.

13. A computer program product comprising a non-transitory computer readable storage medium having program instructions embodied therewith, the program instructions executable by a computer processor to cause the computer processor to perform a method, comprising:
providing the application program for carrying out the method;
assigning a work schedule to the end-user, the work schedule comprising a first list of days and hours for each of the respective days in which the end-user should be using the application program;
indexing and storing data and information in a database for one or more activities completed by the end-user during the work schedule, wherein the data and information comprises a description, a start time, an end time, and a duration for each respective activity of the one or more activities;
assigning each respective activity to one or more status categories, the one or more status categories comprising first active, second active, phone calls, and logout;
calculating one or more productivity scores for the end-user, the one or more productivity scores comprising a current month score spanning from an first selected day of a current month to a second selected day of the current month, wherein the calculating is based on the duration for the one or more activities in the first active status category and the first list of days and hours in the work schedule for the current month;
transmitting the indexed and stored data and information for the one or more activities, the one or more status categories assigned to each of the one or more activities, and the one or more productivity scores to an administrator of the application program; and
displaying a user interface for the administrator, the user interface comprising:
the activity summary, comprising a chronological history for each of the one or more status categories, wherein the chronological history includes at least a portion of the work schedule;
a first register comprising each of the one or more activities completed by the end-user during the work schedule, the one or more status categories assigned to each respective activity of the one or more activities completed by the end-user during the work schedule, and the description of each respective activity of the one or more activities completed by the end-user during the work schedule; and
the one or more productivity scores for the end-user.

14. The computer program product of claim 13, wherein the one or more activities comprises website visited, hyperlink clicked, phone call, application program log-in, application program log-off, and inactivity.

15. The computer program product of claim 14, wherein the first active status category comprises website visited, hyperlink clicked, and application program login.

16. The computer program product of claim 14, wherein the second active status category comprises inactivity, wherein the inactivity is defined by a first predetermined period in which the end-user is not engaged in another activity of the one or more activities.

17. The computer program product of claim 16, wherein the one or more status categories further comprises a third active;
wherein the third active status category comprises inactivity;
wherein the inactivity is defined by a second predetermined period in which the end-user is not engaged in another activity of the one or more activities; and
wherein the second predetermined period is greater than the first predetermined period.

18. The computer program product of claim 13, wherein the one or more status categories further comprises a calendar;
wherein the calendar comprises a second list of days and hours for each of the respective days in which the end-user should not be using the application program.

19. The computer program product of claim 14, wherein the application program log-off is defined by an end-user instruction to end access to the application program.

20. The computer program product of claim 13, wherein the one or more productivity scores further comprises a total score spanning from the first selected day of an initial month to the second selected day of the current month, the first selected day being when the end-user started using the application program, wherein the calculating is based on the duration for the one or more end-user activities in the first active status category and the first list of days and hours in the work schedule for each month since the initial month.
